(19) United States
(12) Patent Application Publication
(10) Pub. No.: US 2013/0324121 A1
(43) Pub. Date: Dec. 5, 2013

(54) APPARATUS AND METHOD FOR MACHINE-TO-MACHINE COMMUNICATIONS

(71) Applicant: SAMSUNG SDS CO., LTD., Seoul (KR)

(72) Inventors: Soon Mok KWON, Seungnam-si (KR); Chung Hyeok LEE, Seoul (KR); Dong Ho YOO, Seoul (KR); Jin-Yeop CHANG, Seoul (KR)

(21) Appl. No.: 13/905,887

(22) Filed: May 30, 2013

(30) Foreign Application Priority Data
May 30, 2012 (KR) 10-2012-0057648
Oct. 31, 2012 (KR) 10-2012-0121701

(51) Int. Cl. H04W 4/00

(52) U.S. Cl. CPC H04W 4/005
USPC 455/435.1

(57) ABSTRACT

Provided are an apparatus and method for executing machine-to-machine (M2M) communications. A device is abstracted through a pre-stored device master template and a pre-stored resource master template, M2M communications are managed through an interface to access resources, and information is periodically synchronized. A problem of system scalability and a problem of heterogeneity of interfaces to access resources may be solved and synchronization may be performed while a load of a network service capability layer (NSCL) is minimized without deteriorating service quality.

### CROSS-REFERENCE TO RELATED APPLICATION

This application claims priority to and the benefit of Korean Patent Application Nos. 10-2012-0057648 and 10-2012-0121701, filed on May 30, 2012 and Oct. 31, 2012, respectively, the disclosures of which are incorporated herein by reference in their entirety.

### BACKGROUND

1. Field of the Invention

The present invention relates to an apparatus and method for machine-to-machine (M2M) communications, and more particularly, to an apparatus and method for abstracting a device through a pre-stored device master template and a pre-stored resource master template, executing M2M communications through interfaces to access resources, and periodically synchronizing information.

2. Discussion of Related Art

To activate M2M communication services, the European Telecommunications Standards Institute (ETSI), which is an international standardization organization, has created ETSI M2M standards. The ETSI M2M standard defines concepts of a network application (NA), a device application (DA), a network service capability layer (NSCL), and a service capability layer (SCL), and the like, and enhances convenience of service development by standardizing a uniform resource identifier (URI) for accessing resources based on a representational state transfer (REST).

Current M2M system has the following problems. The first problem relates to system scalability. When a large number of devices are connected to one NSCL, performance may be degraded. The second problem relates to heterogeneity of interfaces to access resources. An access interface may differ according to a manufacturer or a model even for the same type of devices. The heterogeneity problem may occur in both the form and the semantics. In terms of the form, communication protocols may differ from each other. In terms of the semantics, languages (namespaces, taxonomies, grammars, and the like) in which contents of payloads (protocols' service data units) are written may differ from each other.

Also, the NSCL may include a read/write buffer for smooth communication between the device and the NA. When the buffer is utilized, data to be sent from the NA to the device or data to be sent from the device to the NA is first stored in the buffer. Using the buffer, it is possible to increase the availability of data and reduce the number of redundant requests. A container-related URI, network interworking proxy (NIP), or the like defined in the ETSI M2M standard may be used to access the buffer.

When the read/write buffer is used, the efficiency of synchronization significantly affects the overall system performance. When a synchronization frequency is excessively high in a state in which a large number of NAs and a large number of devices are connected to one NSCL, a load of a system in which the NSCL is constructed is increased and consequently system construction cost is increased. On the other hand, when the synchronization frequency is excessively low, the load of the system is decreased but a requirement such as a message transfer speed desired by the NA may not be satisfied. Accordingly, there is a need for a method of efficiently performing synchronization in consideration of M2M communication characteristics such as a short packet length, a large number of packets, and various device specs.

In Korean Patent No. 10-0998753 granted on Nov. 30, 2010 (KT CORPORATION) (hereinafter referred to as Patent Literature 1), an M2M module having an urgent situation notification function, an M2M device selectively connected to the M2M module, and a method of driving the same are disclosed. In Patent Literature 1, technology for receiving urgent situation notification information from the M2M device by requesting the M2M device to perform an operation of checking a data format capable of being provided by the connected M2M device and acquiring urgent situation notification information having the data format, and for transmitting the urgent situation notification information acquired from the M2M device to a service server that functions to take action is disclosed.

In Korean Patent No. 10-1048854 granted on Jul. 6, 2011 (KT CORPORATION) (hereinafter referred to as Patent Literature 2), a service control method for subscriber traffic data of an M2Mapplication and its system are disclosed. In Patent Literature 2, technology for checking recognition information according to a type of selectively connected device and tendency information about an application driven by the device, delivering the recognition information and the tendency information to an M2M control server, and controlling the subscriber traffic data, which is transmitted and received based on service quality reference information of a subscriber recognized based on the tendency information about the application received from the M2M module, to be within a limited range.

### SUMMARY OF THE INVENTION

The present invention is directed to providing an M2M communication apparatus and method for abstracting a device through a pre-stored device master template and a pre-stored resource master template, executing M2M communications through an interface to access resources, and periodically synchronizing information.

Also, the present invention is directed to providing a computer-readable recording medium recording a program for causing a computer to execute an M2M communication method of abstracting a device through a pre-stored device master template and a pre-stored resource master template, executing M2M communications through an interface to access resources, and periodically synchronizing information.

According to a first aspect of the present invention, there is provided an apparatus for executing M2M communications, including: a storage unit configured to store a device master template and a resource master template; and a registration unit configured to register a device through the device master template pre-stored in the storage unit and the resource master template pre-stored in the storage unit upon receiving a registration request message from the device.

According to a second aspect of the present invention, there is provided a method of executing M2M communications, including: receiving a registration request message from a device; and registering a device through a pre-stored device master template and a pre-stored resource master template.

According to a third aspect of the present invention, there is provided a computer-readable recording medium recording a program for causing a computer to execute the above-described method.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram illustrating an M2M communication apparatus according to an exemplary embodiment of the present invention;

FIG. 2 is a block diagram illustrating details of a configuration of the M2M communication apparatus according to an exemplary embodiment of the present invention;

FIG. 3 is a diagram illustrating an example of device master entries according to an exemplary embodiment of the present invention;

FIG. 4 is a diagram illustrating an example of resource master entries according to an exemplary embodiment of the present invention;

FIG. 5 is a diagram illustrating a device registration operation according to an exemplary embodiment of the present invention;

FIG. 6 is a diagram illustrating an example of a virtualized device instance according to an exemplary embodiment of the present invention;

FIG. 7 is a diagram illustrating an example of a resource chunk instance according to an exemplary embodiment of the present invention;

FIG. 8 is a block diagram illustrating details of a configuration of a synchronization unit according to an exemplary embodiment of the present invention;

FIG. 9 is a diagram illustrating an example of requirements of an NA according to an exemplary embodiment of the present invention;

FIG. 10 is a diagram illustrating an example a merged period for a device according to an exemplary embodiment of the present invention;

FIGS. 11 and 12 are diagrams illustrating a transaction management operation according to an exemplary embodiment of the present invention;

FIG. 13 is a diagram illustrating an example of TSD information according to an exemplary embodiment of the present invention;

FIG. 14 is a diagram illustrating an example of elements constituting a task set according to an exemplary embodiment of the present invention;

FIG. 15 is a diagram illustrating an example of a task set according to an exemplary embodiment of the present invention;

FIG. 16 is a diagram illustrating an example of a transaction serving as a target of push gain calculation in TSD information according to an exemplary embodiment of the present invention;

FIG. 17 is a diagram illustrating an example of a throughput index for a transaction belonging to TSD information according to an exemplary embodiment of the present invention;

FIG. 18 is a diagram illustrating an example of a transaction selection operation according to an exemplary embodiment of the present invention;

FIG. 19 is a sequence diagram illustrating an M2M communication method according to an exemplary embodiment of the present invention; and

FIG. 20 is a sequence diagram illustrating details of a synchronization method according to an exemplary embodiment of the present invention.

### DETAILED DESCRIPTION OF EXEMPLARY EMBODIMENTS

An M2M communication apparatus and method according to exemplary embodiments of the present invention will be described in detail below with reference to the accompanying drawings.

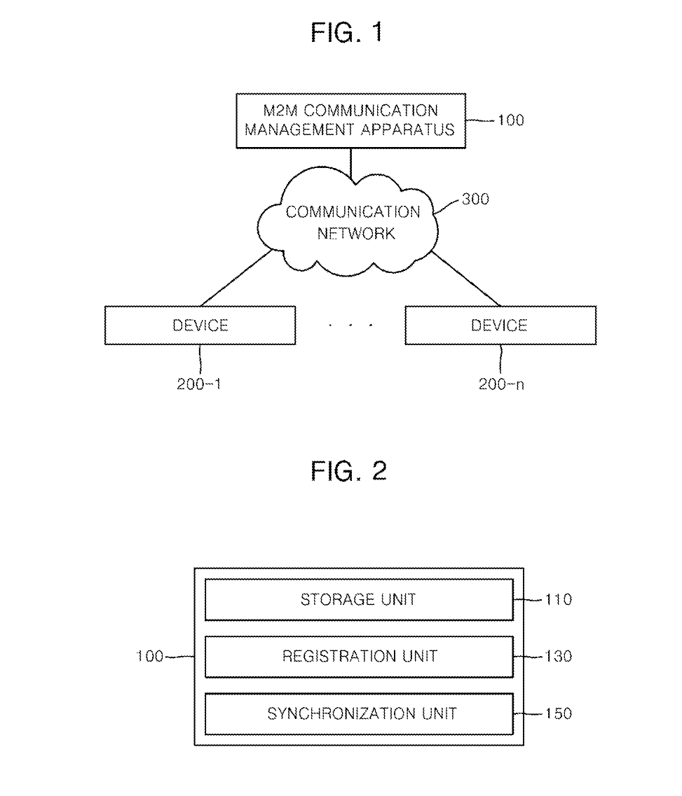

FIG. 1 is a block diagram illustrating an M2M communication apparatus according to an exemplary embodiment of the present invention.

Referring to FIG. 1, the M2M communication apparatus 100 according to the exemplary embodiment of the present invention is connectable to a plurality of devices 200-1 to 200-n through a communication network 300.

As an apparatus to be used for M2M communications, the M2M communication apparatus 100 performs device registration and provides a resource access interface or the like for a device. The M2M communication apparatus 100 corresponds to an “NSCL” and an “NA” defined in the M2M standard established by ETSI.

Here, as a type of service platform, the NSCL provides communication and resource access. As an M2Mapplication registered in the NSCL, the NA provides a user with a service by utilizing the NSCL and another SCL. That is, the device registration is performed through the NSCL, and data transmission and reception are performed between the NA and a DA. Data synchronization is performed according to a request of the NA or DA through the NSCL.

Also, resources are declared within the NA. The declared resources represent contents about resources to be accessed when the NA operates. For example, the declared resources are described in specs or source codes of the NA. That is, when the NA is created, the resources can be handled as accessible variables or objects. Thereafter, when the NA is executed and connected to actual devices, device resources are connected to the variables or objects and the NA performs a task. As described above, the variables or objects represent the declared resources in the NA.

As devices that request M2M communications, devices 200-1 to 200-n are a thermostat, an air conditioner, a heater, a television, and the like. The devices 200-1 to 200-n may be standard devices that conform to the ETSI M2M standard or proprietary devices that do not conform to the ETSI M2M standard. The devices 200-1 to 200-n correspond to the “DA” defined in the M2M standard established by ETSI.

The devices 200-1 to 200-n request the M2M communication apparatus 100 to register themselves devices 200-1 to 200-n for the M2M communications.

The communication network 300 may include a broadcasting network, a telephone network, and the like as well as data communication networks including a local area network (LAN), a metropolitan area network (MAN), a wide area network (WAN), the Internet, and the like. The communication network 300 may use any communication type regardless of a wired or wireless type.

FIG. 2 is a block diagram illustrating details of a configuration of the M2M communication apparatus according to an exemplary embodiment of the present invention.

Referring to FIG. 2, the M2M communication apparatus 100 includes a storage unit 110, a registration unit 130, and a synchronization unit 150.

The storage unit 110 stores a device master template and a resource master template. Also, the storage unit 110 may include a data storage space such as a read/write buffer. The read/write buffer is used for smooth communication between the NA and the device.

Here, the device master template includes a plurality of device master entries. The device master entries include device manufacturer identification information, device identification information, device communication information, and device resource information.

The device manufacturer identification information is a unique code for identifying a manufacturer of a device, including a manufacturer name, a global trade item number (GTIN) code, and the like. As a unique code for identifying the device, the device identification information is a serial number of the device, an activation code of the device, and the like. The device communication information refers to address information, path information, and the like for enabling the M2M communication apparatus 100 to access the device.

As information about resources supported by the device, the device resource information includes a type of resource, information about whether control is possible, and unique resource identification information capable of being identified within the device. Here, in the type of resource, the taxonomy and/or namespace defined in a corresponding resource master entry are used as will be described later.

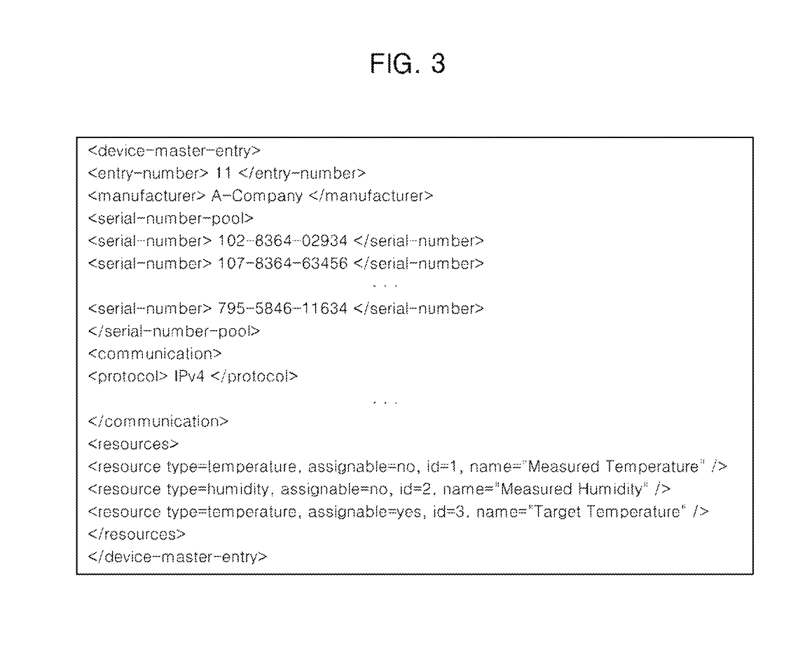

FIG. 3 is a diagram illustrating an example of device master entries according to an exemplary embodiment of the present invention.

For example, device master entries corresponding to an air conditioner/heater by which a temperature and humidity are measureable are as follows.

Referring to FIG. 3, the device manufacturer identification information includes a manufacturer name “A-Company” which is a unique code for identifying a manufacturer through a tag “manufacturer.” The device identification information includes serial numbers “102-8364-02934,” “107-8364-63456,” “795-5846-11634,” and the like which are unique codes for identifying a device through tags “serial-number-pool” and “serial-number.” The device communication information includes a protocol type “Internet Protocol version 4 (IPv4)” which is information for accessing the device through tags “communication,” “protocol,” and the like.

The device resource information includes a “temperature and humidity” which are information about resources supported by the device through tags “resources” and “resource”. Here, in the device resource information, the “temperature” or “humidity” which is a type of resource is represented through a resource-specific attribute “type,” “yes” or “no” indicating whether control is possible is represented through an attribute “assignable,” and “1-Measured Temperature,” “2-Measured Humidity,” or “3-Target Temperature,” which is unique resource identification information capable of being identified within the device through attributes “id” and “name,” is represented.

The resource master template includes a plurality of resource master entries. The resource master entry includes representation format specification (e.g. XML, JSON, RDF) of resource content, and taxonomy and/or namespace specification for writing resource content. Here, the resource content represents content of a resource measurable/observable/controllable in the device. The resource corresponds to “<container>” in a RESTful URI structure defined in the ETSI M2M standard. For example, in the case of an air conditioner equipped with a temperature sensor, resource content of the air conditioner is a temperature measurement value (measurable content), a target temperature value (controllable content), or the like.

The representation format specification of the resource content denotes information about a standardized representation language such as extensible markup language (XML) and JavaScript object notation (JSON). For example, the XML representation formation may be defined by document type definition (DTD).

The taxonomy and/or namespace specification to be used for the representation of the resource content represents information about terms set to be used for the representation of resource content among various terms for writing the resource content.

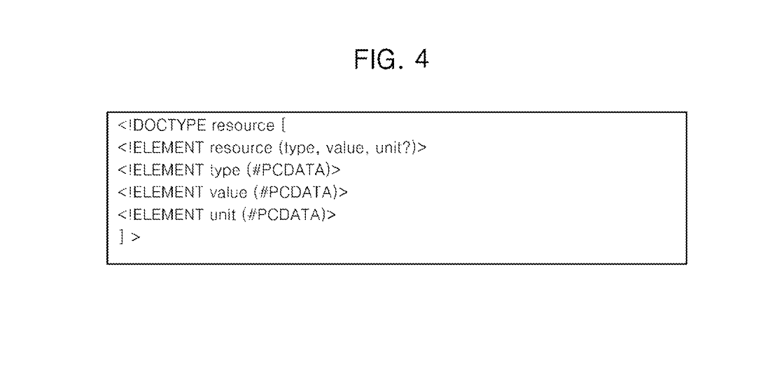

FIG. 4 is a diagram illustrating an example of resource master entries according to an exemplary embodiment of the present invention.

Referring to FIG. 4, the resource master entry includes representation format specification of the resource content and taxonomy and/or namespace specification to be used for writing the resource content.

In the representation format specification of the resource content, a “type,” a “value,” and a “unit,” which are the representation format of the resource content, are defined through DTD language.

In the taxonomy and/or namespace specification to be used for the representation of the resource content, “parsed character data (PCDATA)” is defined as a part in which the taxonomy and/or namespace to be used for the representation of the resource content are designated in the format represented through the DTD language. For example, in the resource master entry for a temperature value, a field “type” includes a “temperature,” a field “value” includes a “numerical value,” and a field “unit” includes “Celsius.” In the resource master entry for a humidity value, the field “type” includes “humidity,” the field “value” includes a “numerical value,” and the field “unit” includes a “percent.”

Upon receiving a registration request message from the first device 200-1, the registration unit 130 registers the first device 200-1 through a device master template a resource master template pre-stored in the storage unit 110 and a resource master template pre-stored in the storage unit 110. Here, the registration request message includes device manufacturer identification information, device identification information, and the like. That is, the registration unit 130 registers the first device 200-1 by generating a virtualized device instance and a resource chunk instance corresponding to the first device 200-1 through the device master template and the resource master template and storing the virtualized device instance and the resource chunk instance in the storage unit 110.

More specifically, the registration unit 130 retrieves a device master entry corresponding to the first device 200-1 from the device master template stored in the storage unit 110 using the device manufacturer identification information, the device identification, and the like included in the registration request message received from the first device 200-1. In addition, the registration unit 130 generates a virtualized device instance corresponding to the first device 200-1 through the device master entry corresponding to the first device 200-1. Here, the virtualized device instance includes device master entry identification information, device identification information, device communication information, resource chunk instance identification information, and the like.

Also, the registration unit 130 retrieves a resource master entry from the resource master template pre-stored in the storage unit 110 through the device resource information included in the device master entry corresponding to the first device 200-1. In addition, the registration unit 130 generates at least one resource chunk instance through the retrieved resource master entry. Here, the number of generated resource chunk instances is the same as the number of retrieved resource master entries. The resource chunk instance includes at least one piece of resource content generated from the same resource master entry.

At this time, the registration unit 130 may store resource content head data and resource content body data in the storage unit 110 by dividing the resource content included in the resource chunk instance of the first device 200-1 into the resource content head data and the resource content body data. Here, the resource content head data represents metadata of the resource content. For example, the metadata may include resource content identification information, a type of resource, and the like. The resource content body data represents actual data.

That is, the registration unit 130 may independently store and divide the resource content head data and the resource content body data. For example, the registration unit 130 may store resource content head data of the device master template, the resource master template, the virtualized device instance, and the resource chunk instance in a relational database management system (DBMS) and store resource content body data of the resource chunk instance in a not only structured query language (NoSQL) DBMS.

In addition, the registration unit 130 stores the virtualized device instance corresponding to the first device 200-1 and the resource chunk instance of the first device 200-1 in the storage unit 110.

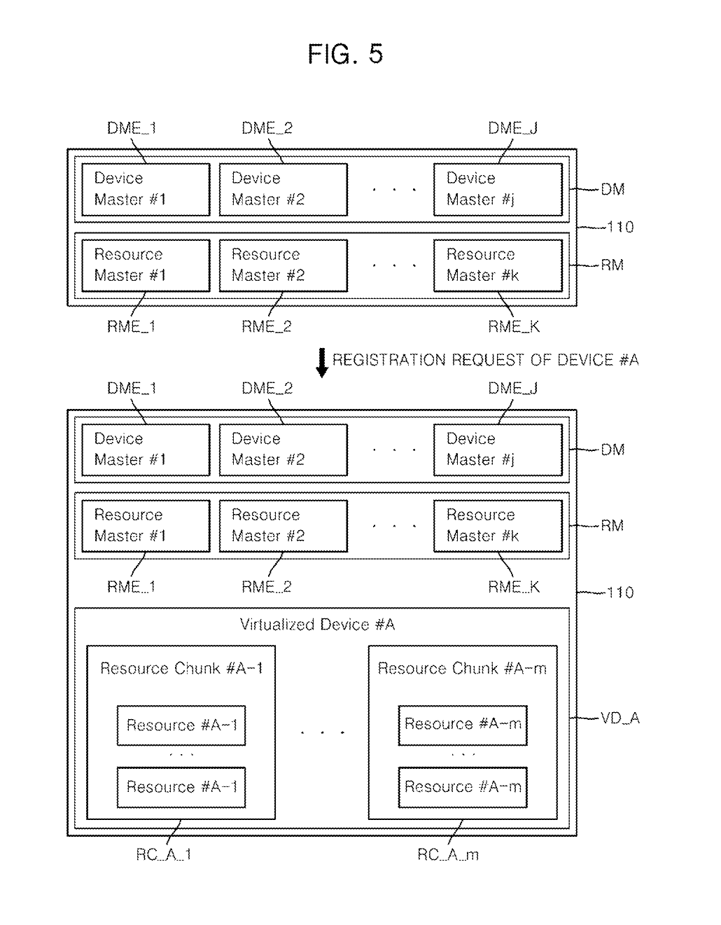

FIG. 5 is a diagram illustrating a device registration operation according to an exemplary embodiment of the present invention.

Referring to FIG. 5, when a device #A sends a registration request message to the M2M communication apparatus 100, the registration unit 130 retrieves a device master entry (one of device master entries DME_1 to DME_J) corresponding to the device #A from a device master template DM pre-stored in the storage unit 110 using device manufacturer identification information, device identification information, and the like included in the registration request message received from the device #A, generates a virtualized device instance VD_A corresponding to the device #A through the retrieved device master entry, and stores the generated virtualized device instance VD_A in the storage unit 110.

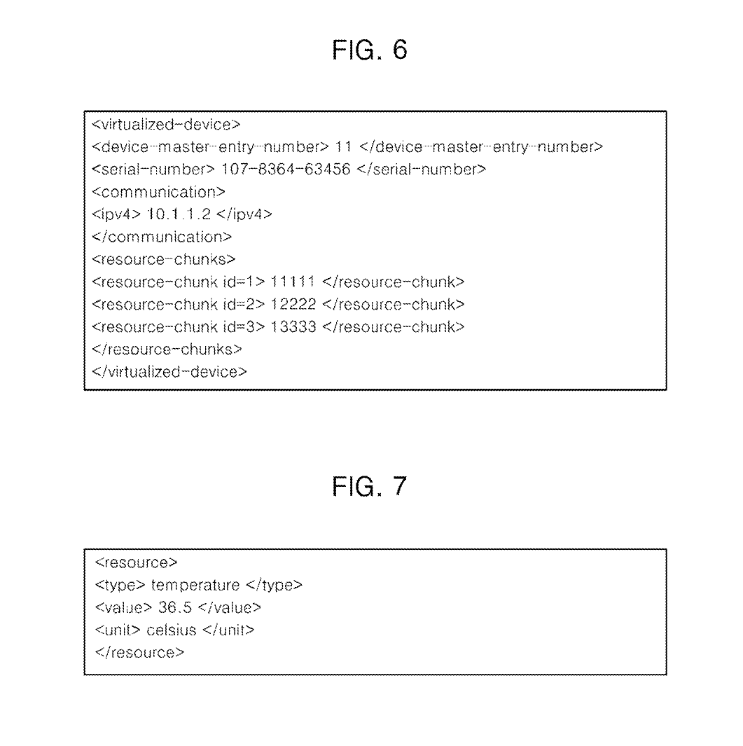

FIG. 6 is a diagram illustrating an example of a virtualized device instance according to an exemplary embodiment of the present invention.

For example, when there is a request for registering the device #A in a state in which the device #A is an air conditioner/heater in which a temperature and humidity are measurable, a manufacturer of the device #A is “A-Company,” and a serial number of the device #A is “107-8364-63456,” and an Internet Protocol (IP) address is “10.1.1.2,” the generated virtualized device instance corresponding to the device #A is as follows.

Referring to FIG. 6, device master entry identification information includes “11” which is identification information of the device master entry used to generate the virtualized device instance corresponding to the device #A through a tag “device-master-entry-number.”

The device identification information includes “107-8364-63456” which is identification information of the device #A through a tag “serial-number.”

The device communication information includes “10.1.1.2,” which is communication information of the device #A, through tags “communication,” “IPv4,” and the like.

The resource chunk instance identification information includes “11111,” “12222,” and “13333,” which are identification information of the resource chunk instance generated for resources supported by the device #A through tags “resource-chunks” and “resource-chunk.”

With reference back to FIG. 5, simultaneously with an operation of generating the virtualized device instance VD_A corresponding to the device #A, the registration unit 130 retrieves a corresponding resource master entry (at least one of RME_1 to RME_k) from a resource master template RM prestored in the storage unit 110 through device resource information included in the device master entry corresponding to the device #A, generates resource chunk instances RC_A_1 to RC_A_m of the device #A through the retrieved resource master entry, and stores the resource chunk instances RC_A_1 to RC_A_m in the storage unit 110.

FIG. 7 is a diagram illustrating an example of a resource chunk instance according to an exemplary embodiment of the present invention.

For example, a resource chunk instance generated through the resource master entry in which resource content is a “temperature measurement value” includes the following resource content.

Referring to FIG. 7, in the resource content, a temperature, which is a type of resource, is represented through a tag “type,” a measurement value of “35.5” is represented through a tag “value,” and “Celsius,” which is a unit of the value, is represented through a tag “unit.”

As described above, the registration unit 130 registers the devices 200-1 to 200-n requesting registration by generating and storing a virtualized device instance and a resource chunk instance corresponding to each of the devices 200-1 to 200-n requesting the registration.

The synchronization unit 150 exchanges a message with the first device 200-1 and synchronizes information within the first device 200-1 corresponding to the resource chunk instance of the first device 200-1 and the resource chunk instance of the first device 200-1 stored in the storage unit 110. That is, the synchronization unit 150 reflects a changed state even in the first device 200-1 when the state of the virtualized device instance corresponding to the first device 200-1 is changed, and reflects a changed state even in the virtualized device instance corresponding to the first device 200-1 when the state of the first device 200-1 is changed.

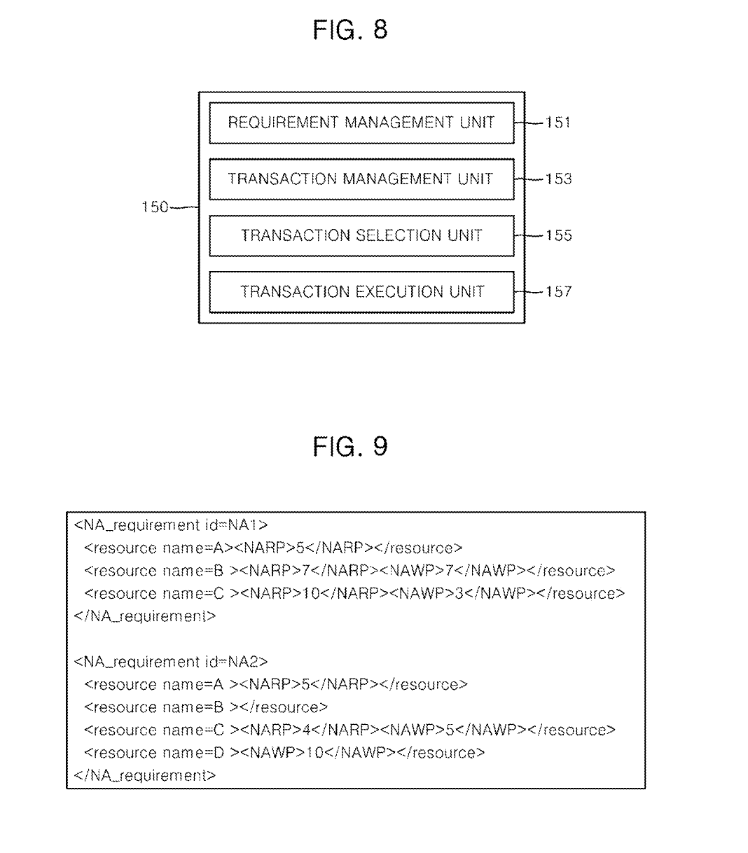

FIG. 8 is a block diagram illustrating details of a configuration of the synchronization unit according to an exemplary embodiment of the present invention.

Referring to FIG. 8, the synchronization unit 150 includes a requirement management unit 151, a transaction management unit 153, a transaction selection unit 155, and a transaction execution unit 157.

The requirement management unit 151 manages requirements for a periodic read/write operation for a specific device in each of a plurality of NAs. That is, the requirement management unit 151 recognizes and maintains information about how requirements of the NA are reflected in a specific device. In addition, the requirement management unit 151 requests the transaction management unit 153 and the transaction selection unit 155 to perform a task, if necessary.

More specifically, when a new NA is registered in the NSCL or when a preregistered NA is changed, the requirement management unit 151 calculates and updates a read/write period for each resource declared in the NA.

Here, the read/write period may be extracted from NA registration information on the NSCL. For example, the NA registration information includes specs defining the NA, NA source codes, and the like. In addition, the read/write period may be determined based on statistical information obtained by monitoring a request of the NA. For example, an average of time intervals of a read request for a specific resource, a moving average, an average of higher-order values, or the like may be determined as a period.

On the other hand, when there are a plurality of reference values for determining a period of one specific resource, the smallest reference value is determined as the period of the resource. For example, when 5 sec or 3 sec is required as the read period for the specific resource according to the NA registration information and the read period according to the statistical information is 10 sec, the read period of the corresponding resource is determined to be 3 sec.

In summary, the requirement management unit 151 calculates the read/write period for a resource X declared in the NA through the following Equations (1).

NAR=Set of periods in which X is read, where the period information is extracted from NA registration information,

nar1=Estimated period value based on statistical information about read request for X of NA,

NAW=Set of periods in which X is written, where the period information is extracted from NA registration information,

naw1=Estimated period value based on statistical information about write request for X of NA,

Read period (NA read period (NARP))=min (NAR∪nar1), and

Write period (NA write period (NAWP))=min (NAW∪naw1) (1)

FIG. 9 is a diagram illustrating an example of requirements of an NA according to an exemplary embodiment of the present invention.

Assuming that there are NA1 and NA2 which are two NAs to be executed on the NSCL, NA1 declares three resources A, B, and C, and NA2 declares four resources A, B, C, and D, the requirement management unit 151 may extract and maintain a resource declared by each NA and information about the read/write periods (NARP and NAWP) for the declared resource as illustrated in FIG. 9.

In addition, when the NA is newly executed and connected to a device, when the device is connected and a read period (NARP) or a write period (NAWP) is changed for a resource of the NA in operation, or when the device is connected and the NA in operation ends, the requirement management unit 151 calculates and updates a merged read/write period (MRP/MWP) for each resource of the device using the read period (NARP) and the write period (NAWP).

Here, the MRP and MWP are calculated for a resource of the device. On the other hand, the read period (NARP) and the write period (NAWP) are calculated for a resource declared in the NA.

For example, the MRP of a resource Y of a specific device is determined to be a minimum value of read periods (NARPs) of resources connected to the resource Y among resources declared by all NAs which are currently in operation. The MWP is also determined by the above-described method. Here, all the NAs that are currently in operation represent all of newly executed NAs and already executed NAs.

In summary, the requirement management unit 151 calculates the MRP and MWP for the resource Y of the specific device through the following Equations (2).

MR=Set of NARP values of resources connected to resource Y among resources declared in all NAs in operation,

MW=Set of NAWP values of resources connected to resource Y among resources declared in all NAs in operation,

MRP=min (MR), and

MWP=min (MW) (2)

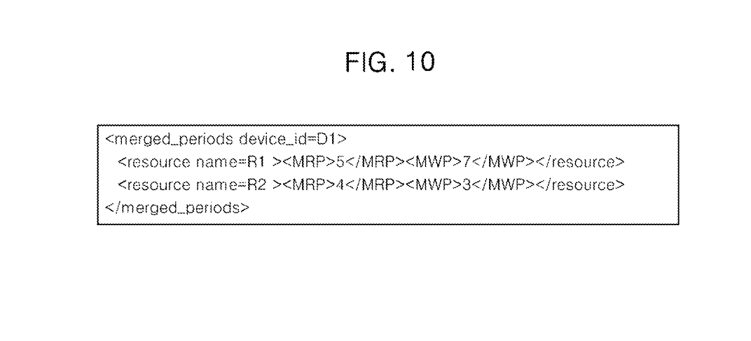

FIG. 10 is a diagram illustrating an example of a merged period for a device according to an exemplary embodiment of the present invention.

Assuming that a device D1 has two resources R1 and R2, NA1 is executed so that resources B and C of NA1 are connected to the resources R1 and R2 of the device D1, respectively, and NA2 is executed so that resources A and C of NA2 are connected to the resources R1 and R2 of the device D1, respectively, the requirement management unit 151 may calculate and maintain information about an MRP and an MWP for the device D1 as illustrated in FIG. 10.

In addition, when the newly calculated MRP and MWP are different from an existing MRP and MWP, the requirement management unit 151 requests the transaction management unit 153 and the transaction selection unit 155 to perform a task. That is, when a requirement change such as addition, change, or deletion is made, the requirement management unit 151 requests the transaction management unit 153 and the transaction selection unit 155 to perform a task. For example, the requirement management unit 151 may request the task while providing the transaction management unit 153 or the transaction selection unit 155 with requirements for the periodic read/write operation from the NA to the device.

The transaction management unit 153 recognizes and manages a transaction supported by the device. That is, the transaction management unit 153 recognizes and updates a message format or a communication scheme supported by the device.

In other words, the transaction management unit 153 recognizes and updates a type of transaction capable of occurring between the NSCL and the device when a change (new registration, change, deletion, or the like) of the device registered in the NSCL is made or when there is a task request of the requirement management unit 151.

Here, the transaction represents an operation in which a transmitter transmits a message to a receiver once or an operation in which the transmitter transmits a message once and receives a response message therefor. In addition, the registration or change of the device includes a change of device identification information as well as a physical connection of the device to the NSCL. For example, the device identification information may be changed when a device manufacturer releases a new product connectable to the NSCL or changes specs of an existing product.

At this time, the transaction generated between the device and the NSCL may be classified based on what is a resource to be used for a read or write operation on the device and which of the device and the NSCL first transmits the message. For example, the transaction includes the following two steps when a resource to be read from the device is A, a resource to be written to the device is B, and the device first transmits the message.

Step 1) The device transmits a message including a value of the resource A and a request for a value to be set in the resource B to the NSCL.

Step 2) The NSCL receiving the message transmitted by the device transmits a response message including the value to be set in the resource B to the device.

That is, it is possible to recognize all possible types of transactions by arbitrarily setting a resource to be read from the device, a resource to be written to the device, and a side from which a message is first transmitted when resources possessed by the device are known. Transactions supported by the device may be some of all the recognized types of transactions.

In summary, the transaction management unit 153 calculates only TSD information including only transactions supported by the device among all types of transactions. At this time, an operation of holding and maintaining the TSD information may be implemented in various types. For example, it is possible to store all elements of the TSD information, store only some rules of the TSD information, or store only transactions not included in the TSD information among all possible transactions.

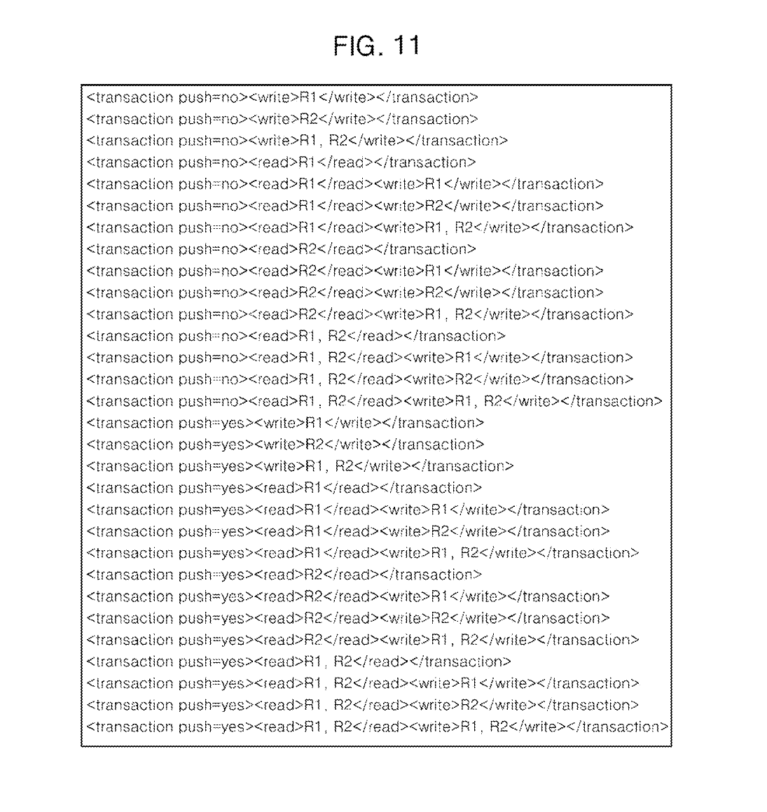

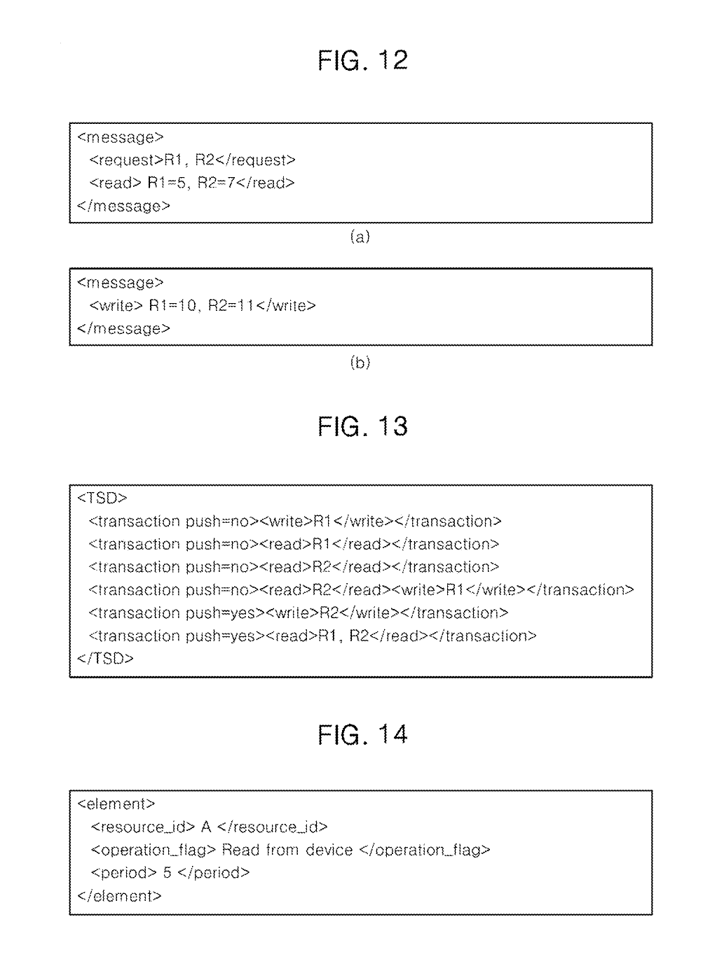

FIGS. 11 and 12 are diagrams illustrating a transaction management operation according to an exemplary embodiment of the present invention.

As illustrated in FIG. 11, the transaction management unit 153 may acquire all possible types of transactions. Here, a ‘push attribute’ of a ‘transaction element’ indicates whether the push attribute is a device push. A ‘read element’ indicates a resource to be read from the device. A ‘write element’ indicates a resource to be written to the device.

For example, in the last transaction, the NSCL reads R1 and R2 values from the device and simultaneously performs an operation of allocating the R1 and R2 values to the device, and the side from which the message is first transmitted is indicated to be the device.

A detailed operation of the transaction will be described. When the R1 and R2 values of a device D1 are currently 5 and 7, respectively, the device D1 transmits a message as illustrated in FIG. 12(a) to the NSCL. Here, a ‘request element’ represents a resource to be received from the NSCL. A ‘read element’ represents a value of a resource to be read by the NSCL from the device D1. Thereafter, when the NSCL receiving the message intends to set the R1 and R2 values of the device D1 to 10 and 11, respectively, a response may be made with a message as illustrated in FIG. 12(b). Here, a ‘write element’ represents a value of a resource to be written by the NSCL to the device D1.

FIG. 13 is a diagram illustrating an example of TSD information according to an exemplary embodiment of the present invention.

The transaction management unit 153 may extract and maintain the TSD information including only transactions supported by the device D1 among all possible types of transactions as illustrated in FIG. 13 by recognizing types of transactions supported by the device D1 using a datasheet of the device D1.

In addition, when there is a change in a type of transaction, the transaction management unit 153 requests the transaction selection unit 155 to perform a task. That is, when the TSD information is changed, the transaction management unit 153 notifies the transaction selection unit 155 of the change. For example, the transaction management unit 153 may notify the transaction selection unit 155 of the change by providing the transaction selection unit 155 with the changed TSD information.

The transaction selection unit 155 determines a transaction type and frequency between the NSCL and the device. That is, the transaction selection unit 155 sets a resource-specific communication request frequency and characteristics of a device-specific communication scheme as main variables, and determines the transaction type and frequency using a greedy algorithm.

In other words, when there is a task request of the requirement management unit 151 or the transaction management unit 153, the transaction selection unit 155 selects a transaction to be actually performed from TSD information for each corresponding device and determines a period in which each selected transaction is performed. In the present invention, a weighted set cover problem is solved using the greedy algorithm. At this time, the MRP, the MWP, the TSD information, and the like are used as main variables.

More specifically, the transaction selection unit 155 extracts a task set using data provided by the requirement management unit 151. Here, as a set including required synchronization tasks, the task set represents a set to be covered in the weighted set cover problem.

Information about each of a resource-specific MRP and MWP becomes an element of the task set. Contents of each element include resource identification information (resource identifier (ID)) within the device, an operation flag for identifying a read or write operation from the NSCL to the device, the MRP or MWP, and the like. The contents of the element may be represented in various formats.

FIG. 14 is a diagram illustrating an example of elements constituting the task set according to an exemplary embodiment of the present invention.

For example, an element in which the MRP of the resource A is 5 sec may include a triple as illustrated in FIG. 14.

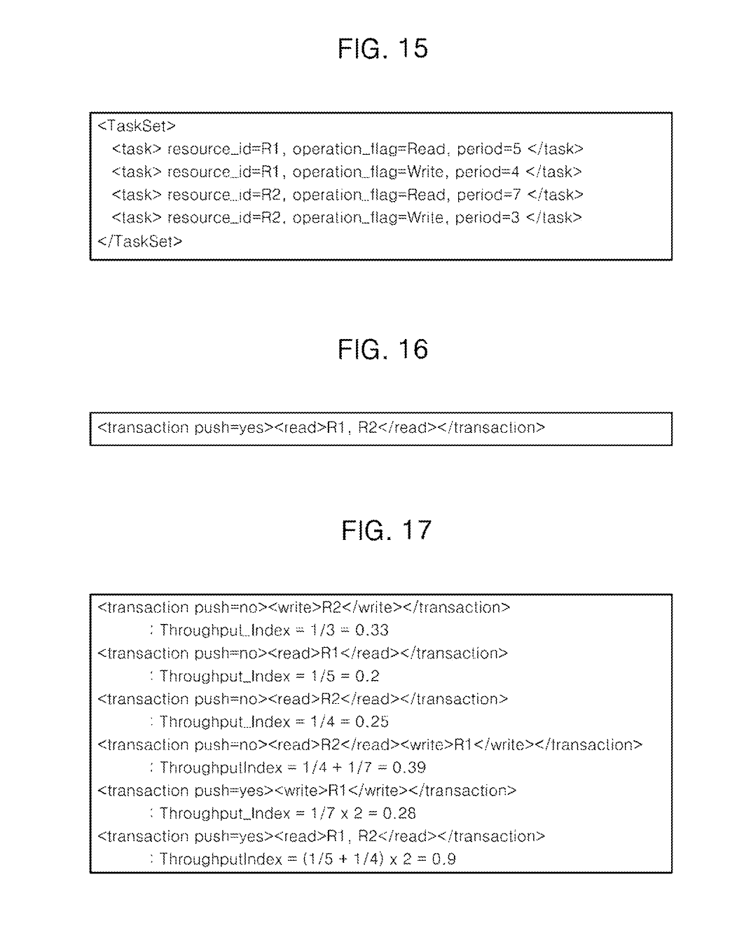

FIG. 15 is a diagram illustrating an example of a task set according to an exemplary embodiment of the present invention.

The transaction selection unit 155 extracts and maintains the task set as illustrated in FIG. 15 using data provided by the requirement management unit 151.

In addition, the transaction selection unit 155 calculates a push gain through the following Equation (3) for a transaction starting with a message transmitted from the device to the NSCL among transactions belonging to the TSD information. In the present invention, the device push represents the case in which the transaction starts with a message transmitted from the device to the NSCL. In general, an amount of network/computing resources of the NSCL consumed for the read or write operation of the same amount is smaller in the transaction of the device push type compared to that of another type different from the device push type.

Push gain=Amount of consumed resources of NSCL when read and write operations of transaction are performed in other type different from device push type/Amount of consumed resources of NSCL when read and write operations of transaction are performed in device push type (3)

Here, the resources of the NSCL to be consumed may be measured through the number of exchanged messages, a consumption amount of a network bandwidth, a central processing unit (CPU) time of an NSCL process, and the like. In addition, a method of measuring resources of the NSCL to be consumed may differ according to detailed implementation contents such as a type of communication protocol, a structure of an NSCL thread, and the like. For example, when an operation is based on a user datagram protocol (UDP) and the number of exchanged messages is used as a resource consumption measure, the total number of messages is 1 and the push gain is calculated to be 1 since the device transmits a message to the NSCL once in the device push type in the case of a transaction in which one resource of the device is read. If the type is not the device push type, the push gain is calculated to be 2 because two messages are used in a process in which the NSCL transmits a resource request and receives a response. That is, it is only necessary that how to calculate the push gain with which reference is determined according to a scheme in which the NSCL is actually constructed. Of course, it is possible to set the same push gain value collectively for all transactions in the device push type without calculating the push gain for an individual transaction in the device push type. In summary, the push gain may be concretely calculated in various types.

FIG. 16 is a diagram illustrating an example of a transaction serving as a target of push gain calculation in TSD information according to an exemplary embodiment of the present invention.

The transaction selection unit 155 calculates the push gain for the transaction corresponding to the device push as illustrated in FIG. 16 among transactions belonging to the TSD information of the device D1. The push gain for the transaction is assumed to be 2.

In addition, the transaction selection unit 155 calculates a throughput index for each transaction belonging to the TSD information. Here, the throughput index is an index indicating how many user requests can be processed in the transaction. That is, the transaction selection unit 155 may calculate the throughput index for a transaction X belonging to the TSD information through the following Equations (4).

Throughput index when X does not correspond to device push type=Sum of reciprocals of MRPs or MWPs of elements executable by X among elements of task set, and

Throughput index when X corresponds to device push type=(Sum of reciprocals of MRPs or MWPs of elements executable by X among elements of task set)*(Push gain of X) (4)

That is, the throughput index is determined to be a value in proportion to a frequency of execution of elements executable by the transaction X among the elements of the task set. When the transaction X is in the device push type, the push gain is ultimately multiplied. When the task set is changed, the throughput index is also changed.

FIG. 17 is a diagram illustrating an example of a throughput index for a transaction belonging to TSD information according to an exemplary embodiment of the present invention.

As illustrated in FIG. 17, the transaction selection unit 155 calculates the throughput index for each of the transactions belonging to the TSD information of the device D1.

In addition, the transaction selection unit 155 calculates a merged action period (MAP) for each transaction belonging to the TSD information. Here, the MAP is an action period of each transaction for satisfying requirements of the NA. That is, the transaction selection unit 155 may calculate the MAP for the transaction X belonging to the TSD information through the following Equation (5).

MAP=Minimum value among MRPs or MWPs of elements executable by X among elements of task set (5)

When the task set is changed, the MAP is also changed.

In addition, by performing the greedy algorithm using the task set based on the throughput index and the MAP for each transaction belonging to the TSD information, the transaction selection unit 155 selects a transaction capable of satisfying requirements of the NA and sets the MAP of the transaction. The greedy algorithm is heuristic for a set cover problem for covering the task set as(with?) elements of the TSD information. At this time, each of the elements of the TSD information may be regarded as a subset of the task set. The greedy algorithm according to an exemplary embodiment of the present invention is shown in the following Table 1.

TABLE 1

Input: TaskSet, TSD
Output: Set of Tuples (selected transaction, MAP)
Repeat while TaskSet is not empty
X = The transaction in TSD with maximum throughput index
(If tie exists, select transaction with minimum of related resources)
T = The merged action period of X
Output = Output ∪ {(X, T)}
TaskSet = TaskSet − {tasks covered by transaction X}
End Repeat

Here, transaction-related resources are resources to be read or written in the transaction.

In summary, the transaction selection unit 155 recognizes and updates a set of tuples.

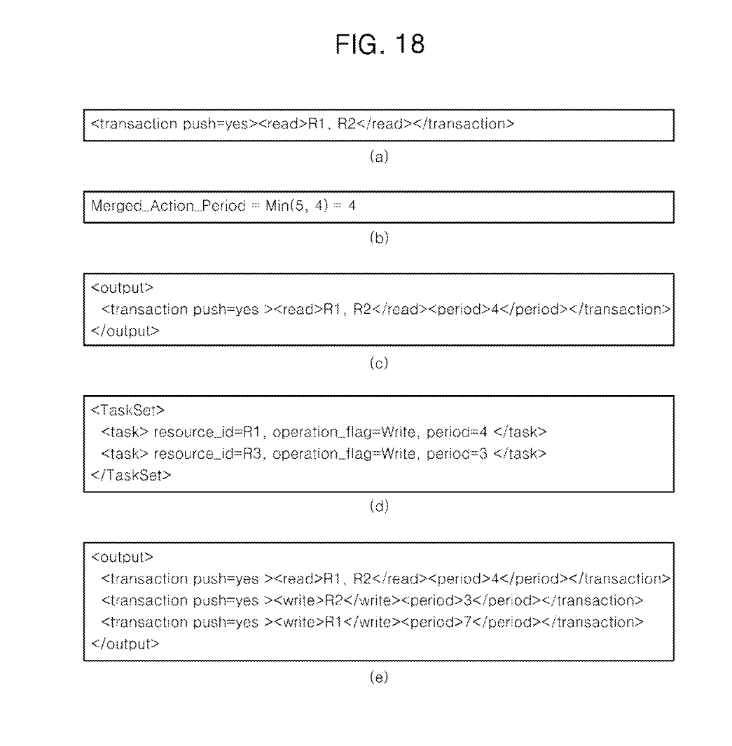

FIG. 18 is a diagram illustrating an example of a transaction selection operation according to an exemplary embodiment of the present invention.

A transaction X of which a throughput index is maximum at the time of first execution of an iterative routine of the greedy algorithm is a transaction illustrated in FIG. 18(a). The MAP of the transaction X is 4 as illustrated in FIG. 18(b). After one iterative routine is executed, the output is the same as illustrated in FIG. 18(c). After the execution of the one iterative routine, tasks processed in the transaction X are removed and the task set is changed as illustrated in FIG. 18(d). Thereafter, when the iterative routine ends, the output is the same as illustrated in FIG. 18(e).

In addition, the transaction selection unit 155 notifies the transaction execution unit 157 that a transaction to be executed has been changed, if necessary. That is, when contents of a tuple set are changed, the transaction selection unit 155 provides the tuple set to the transaction execution unit 157.

The transaction execution unit 157 performs synchronization by performing the transaction selected by the transaction selection unit 155. That is, the transaction execution unit 157 performs synchronization based on the tuple set provided by the transaction selection unit 155. In other words, the NSCL periodically performs a transaction not corresponding to the device push type, and the transaction execution unit 157 requests the device to periodically transmit a message with which a transaction starts in the transaction corresponding to the device push type.

On the other hand, although an example in which the device master entry, the resource master entry, the virtualized device instance, the resource chunk instance, the TSD information, the task set, and the like are represented through JSON, XML, DTD, and the like has been described according to the exemplary embodiment of the present invention, the present invention is not limited thereto. The representation may be made in various formats according to an exemplary embodiment of the present invention.

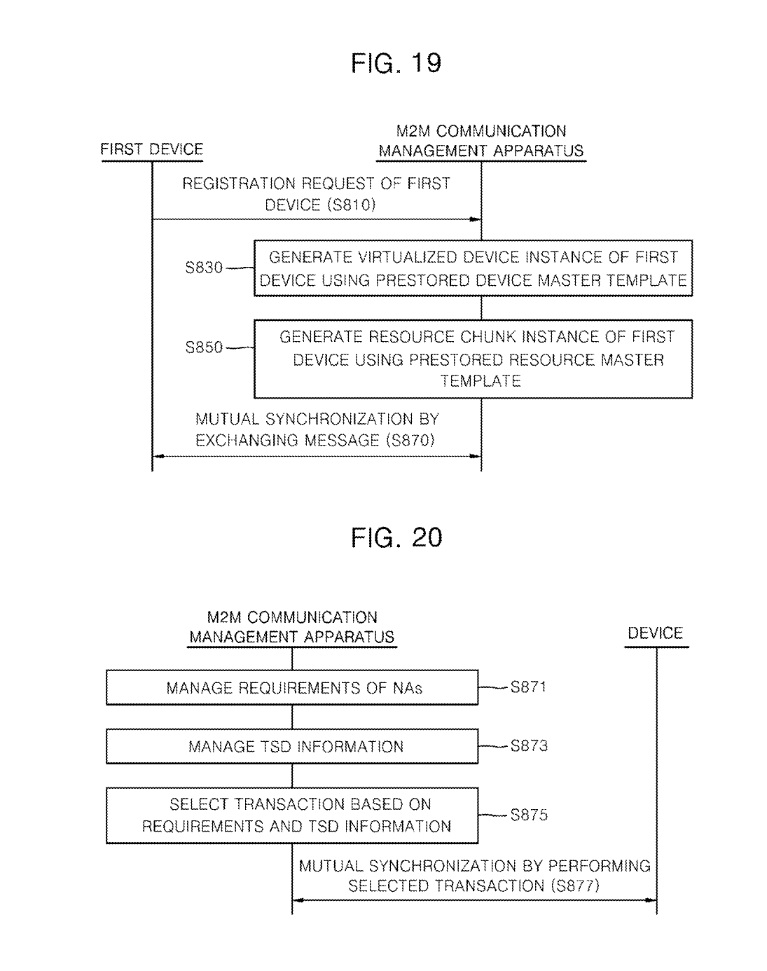

FIG. 19 is a sequence diagram illustrating an M2M communication method according to an exemplary embodiment of the present invention.

The first device 200-1 requests the M2M communication apparatus 100 to register the first device 200-1 (S810). At this time, the first device 200-1 transmits a registration request message including manufacturer identification information of the first device 200-1, identification information of the first device 200-1, and the like to the M2M communication apparatus 100.

Then, the M2M communication apparatus 100 registers the first device 200-1 through a pre-stored device master template and a pre-stored resource master template. That is, the M2M communication apparatus 100 registers the first device 200-1 by generating and storing a virtualized device instance and a resource chunk instance corresponding to the first device 200-1 through the device master template and the resource master template.

More specifically, the M2M communication apparatus 100 generates and stores the virtualized device instance of the first device 200-1 using the pre-stored device master template (S830). That is, the M2M communication apparatus 100 retrieves the device master entry corresponding to the first device 200-1 from the pre-stored device master template using the device manufacturer identification information, the device identification information, and the like included in the registration request message received from the first device 200-1, and generates and stores the virtualized device instance corresponding to the first device 200-1 through the retrieved device master entry.

In addition, the M2M communication apparatus 100 generates and stores the resource chunk instance of the first device 200-1 using the pre-stored resource master template (S850). That is, the M2M communication apparatus 100 retrieves the corresponding resource master entry from the pre-stored resource master template through device resource information included in the device master entry corresponding to the first device 200-1, and generates and stores the resource chunk instance of the first device 200-1 through the retrieved resource master entry.

Thereafter, the M2M communication apparatus 100 synchronizes information with the first device 200-1 while exchanging a message therewith (S870).

On the other hand, although an example in which the step (S850) of generating the resource chunk instance is performed after the step (S830) of generating the virtualized device instance is performed has been described above, the present invention is not limited thereto. According to an exemplary embodiment, the step (S850) of generating the resource chunk instance may be performed before the step (S830) of generating the virtualized device instance. Alternatively, the step (S830) of generating the virtualized device instance and the step (S850) of generating the resource chunk instance may be simultaneously performed.

FIG. 20 is a sequence diagram illustrating details of a synchronization method according to an exemplary embodiment of the present invention. The M2M communication apparatus 100 manages requirements of NAs (S871).

That is, the M2M communication apparatus 100 manages requirements for a periodic read/write operation from each of a plurality of NAs to a specific device. More specifically, when a new NA is registered in the NSCL or a preregistered NA is changed, the M2M communication apparatus 100 calculates and updates a read/write period for each resource declared in the NA. In addition, when the NA is newly executed and connected to a device, when the device is connected and a read period (NARP) or a write period (NAWP) is changed for a resource of the NA in operation, or when the device is connected and the NA in operation ends, the M2M communication apparatus 100 calculates and updates an MRP or an MWP for each resource of the device using the read period (NARP) and the write period (NAWP).

Then, the M2M communication apparatus 100 manages TSD information (S873). That is, the M2M communication apparatus 100 recognizes and manages a transaction to be supported by the device. More specifically, the M2M communication apparatus 100 calculates device-specific TSD information including only transactions supported by the device among all types of transactions.

Thereafter, the M2M communication apparatus 100 selects a transaction based on the requirements and the TSD information (S875). That is, the M2M communication apparatus 100 sets a resource-specific communication request frequency and characteristics of a device-specific communication scheme as main variables, and determines the transaction type and frequency using a greedy algorithm. More specifically, the M2M communication apparatus 100 extracts a task set using the requirements of the NAs. In addition, the M2M communication apparatus 100 calculates a push gain for a transaction starting with a message transmitted from the device to the NSCL among transactions belonging to the TSD information. In addition, the M2M communication apparatus 100 calculates a throughput index and an MAP for each transaction belonging to the TSD information. In addition, the M2M communication apparatus 100 performs the greedy algorithm using the task set based on the throughput index and the MAP for each transaction belonging to the TSD information, selects a transaction capable of satisfying requirements of the NA, and sets the MAP of the transaction.

Ultimately, the M2M communication apparatus 100 synchronizes information with the device by performing the selected transaction (S877).

According to the M2M communication apparatus and method according to the present invention, a device may use an M2M communication service through a device master template and a resource master template, which are already generated and stored. Accordingly, when a new device appears, the new device may also use the M2M communication service by generating and adding a device master entry and a resource master entry corresponding to the new device based on the pre-existing master templates.

In addition, it is possible to abstract a device through a device master template and a resource master template in which device's communication specification (e.g. supported communication protocols), representation format specification (e.g. XML, JSON, RDF) of resource content, and taxonomy and/or namespace specification for writing resource content are stored according to each device, and to provide an interface to access resources. Accordingly, interfaces may differ according to a manufacturer or model even for the same type of devices. However, when the device master template and the resource master template according to an exemplary embodiment of the present invention are used, devices for which interfaces are different may also use an M2M communication service. Accordingly, it is possible to solve a problem of heterogeneity of the interfaces.

In addition, when the synchronization method according to an exemplary embodiment of the present invention is used, it is possible to minimize load at NSCL without degrading service quality. This is accomplished by performing only the selected transactions using the information of NA's requirements and transaction-supported-by-device (TSD). Accordingly, it is possible to relieve the scalability problem by reducing the performance requirements of the NSCL generated with an increase in the number of connected devices and to reduce infrastructure construction cost necessary for an M2M communication service.

The present invention can also be embodied as computer-readable codes on a computer-readable recording medium. The computer-readable recording medium is any data storage device that may store data readable by a computer device. Examples of the computer-readable recording medium are a read-only memory (ROM), a random-access memory (RAM), a compact disc (CD)-ROM, a magnetic tapes, a floppy disk, an optical data storage device, and the computer-readable recording medium may also be implemented with carrier waves (such as data transmission over the Internet). The computer-readable recording medium may also be distributed to computer devices connected over a wired/wireless network and the computer-readable codes may be stored and executed in a distributed system.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus configured to execute machine-to-machine (M2M) communications, comprising:
a storage configured to store a device master template and a resource master template; and
a registration unit configured to register a device using the device master template stored in the storage and the resource master template stored in the storage upon receiving a registration request message from the device.

2. The apparatus of claim 1,
wherein the device master template comprises a device master entry including device manufacturer identification information, device identification information, a device communication specification, and device resource information, and
wherein the resource master template comprises a resource master entry including a representation format specification of resource content and taxonomy and/or a namespace specification to be used as a representation of the resource content.

3. The apparatus of claim 1, wherein the registration unit registers the device by generating a virtualized device instance and a resource chunk instance corresponding to the device using the device master template and the resource master template and storing the virtualized device instance and the resource chunk instance in the storage.

4. The apparatus of claim 3, wherein the registration unit retrieves a device master entry corresponding to the device from the device master template stored in the storage using the registration request message, retrieves a resource master entry supported by the device from the resource master template stored in the storage using the retrieved device master entry corresponding to the device, and generates the virtualized device instance and the resource chunk instance corresponding to the device using the retrieved device master entry corresponding to the device and the retrieved resource master entry supported by the device.

5. The apparatus of claim 3, further comprising a synchronization unit configured to exchange a message with the device and synchronize the resource chunk instance stored in the storage and information within the device corresponding to the resource chunk instance.

6. The apparatus of claim 5, wherein the synchronization unit comprises:
a requirement management unit configured to manage requirements for a periodic read or write operation from a network application (NA) to the device;
a transaction management unit configured to acquire transaction-supported-by-device (TSD) information by recognizing a transaction supported by the device;
a transaction selection unit configured to select a transaction from the TSD information using the requirements and the TSD information and set a merged action period (MAP) of the selected transaction; and
a transaction execution unit configured to synchronize information by performing the selected transaction.

7. The apparatus of claim 6, wherein the transaction selection unit extracts a task set using the requirements, calculates a throughput index and the MAP for transactions belonging to the TSD information, selects a transaction from the TSD information using the task set based on the throughput index and the MAP for the transactions belonging to the TSD information, and sets the MAP of the selected transaction.

8. A method of executing machine-to-machine (M2M) communications, comprising:
receiving a registration request message from a device; and
registering the device using a stored device master template and a stored resource master template.

9. The method of claim 8,
wherein the device master template comprises a device master entry including device manufacturer identification information, device identification information, a device communication specification, and device resource information, and
wherein the resource master template comprises a resource master entry including a representation format specification of resource content and taxonomy and/or a namespace specification to be used as a representation of the resource content.

10. The method of claim 8, wherein the registering comprises generating and storing a virtualized device instance and a resource chunk instance corresponding to the device using the device master template and the resource master template.

11. The method of claim 10, wherein the registering comprises:
retrieving a device master entry corresponding to the device from the stored device master template using the registration request message;
retrieving a resource master entry supported by the device from the stored resource master template using the retrieved device master entry corresponding to the device; and
generating the virtualized device instance and the resource chunk instance corresponding to the device using the retrieved device master entry corresponding to the device and the retrieved resource master entry supported by the device.

12. The method of claim 10, further comprising exchanging a message with the device and synchronizing the resource chunk instance and information within the device corresponding to the resource chunk instance.

13. The method of claim 12, wherein the synchronizing comprises:
managing requirements for a periodic read or write operation from a network application (NA) to the device;
acquiring transaction-supported-by-device (TSD) information by recognizing a transaction supported by the device;
selecting a transaction from the TSD information using the requirements and the TSD information and setting a a merged action period (MAP) of the selected transaction; and
synchronizing information by performing the selected transaction.

14. The method of claim 13, wherein the selecting comprises:
extracting a task set using the requirements;
calculating a throughput index and the MAP for transactions belonging to the TSD information; and
selecting a transaction from the TSD information using the task set based on the throughput index and the MAP for the transactions belonging to the TSD information, and setting the MAP of the selected transaction.

15. A non-transitory computer-readable media having recorded thereon a program for executing the method of claim 8.

16. A communication apparatus, comprising:
a registration module configured to receive a registration request from a device via a network, and to register the device by generating and storing information related to the device using a device master template and a resource master template; and
a synchronization module configured to synchronize the stored information related to the device with other information corresponding to the stored information, the other information being stored in the device.

17. The communication apparatus of claim 16, wherein the information related to the device comprises a resource chunk instance corresponding to the device.

18. The communication apparatus of claim 16, further comprising a storage configured to store the device master template and the resource master template.

19. The communication apparatus of claim 16, wherein the communication apparatus corresponds to a network service capability layer (NSCL) and a network application (NA) defined in the M2M standard established by the (European Telecommunications Standards Institute ETSI).
